(19) United States
(12) Patent Application Publication
(10) Pub. No.: US 2016/0154240 A1
(43) Pub. Date: Jun. 2, 2016

(54) WEARABLE DISPLAY DEVICE

(71) Applicant: SAMSUNG DISPLAY CO., LTD., Yongin-City (KR)

(72) Inventors: Kwang Hoon LEE, Anyang-si (KR); Mu Gyeom KIM, Hwaseong-si (KR)

(21) Appl. No.: 14/681,451

(22) Filed: Apr. 8, 2015

(30) Foreign Application Priority Data
Dec. 2, 2014 (KR) 10-2014-0170370

(51) Int. Cl. G02B 27/01; G01B 11/14

(52) U.S. Cl. CPC G02B 27/017; G01B 11/14; G02B 2027/0178; G02B 2027/0138

(57) ABSTRACT

A wearable display device includes a display, a location signal receiver, a sensor arrangement, and a controller. The display is mounted on a frame. The location signal receiver receives location information of a user wearing the wearable display device. The sensor arrangement is on the frame and includes one or more sensors to determine distance information of one or more objects surrounding the user. The controller calculates a movement direction of the user based on the location information from the location signal receiver or the distance information from the sensor arrangement and generates a control signal for controlling generation of an image on the display based on the movement direction.

### CROSS-REFERENCE TO RELATED APPLICATION

Korean Patent Application No. 10-2014-0170370, filed on Dec. 2, 2014, and entitled, “Wearable Display Device,” is incorporated by reference herein in its entirety.

### BACKGROUND

1. Field

One or more embodiments described herein relate to a wearable display device.

2. Description of the Related Art

A head mounted display (HMD) has been proposed to be worn like glasses.

Such an HMD displays virtual images to the wearer. The display of the HMD is around 1 inch or less, and the image on the display is magnified by optical technology. Uses of HMDs are anticipated to include movie and game applications, with future generation HMDs expected to provide personal computing applications analogous, for example, to those performed by a smart phone.

Additionally, HMDs are anticipated to be used both indoors and outdoors. Because the HMD display significantly affects the vision of its user, the safety of the user can be compromised especially when used outdoors. For example, when a user wearing an HMD is walking on the street, his vision may be hindered to the extent that he will not be able to recognize a suddenly appearing vehicle or other dangerous objects.

### SUMMARY

In accordance with one or more embodiments, a wearable display device includes a frame; a display, on the frame, to display an image based on a control signal; a location signal receiver to receive location information of the wearable display device; a sensor arrangement on the frame and including one or more sensors to determine distance information of one or more surrounding objects; and a controller including a movement direction calculator to calculate a movement direction of the wearable display device based on the location information from the location signal receiver or the distance information from the sensor arrangement, a control signal generator to generate the control signal based on the movement direction, and a control signal transmitter to transmit the control signal to the display.

The movement direction calculator may calculate the movement direction of the wearable display device (being worn by a user) based on one of the location information or the distance information. The controller may include a location reception state identifier to identify a reception state of the location signal, wherein the movement direction calculator may calculate the movement direction of the wearable display device based on the location information when the reception state of the location signal is indicative of a first state and may calculate the movement direction of the wearable display device based on the distance information when the reception state of the location signal is in a second state.

The movement direction calculator may determine that the reception state of the location signal is in the first state when the reception rate of the location signal exceeds a preset reference value, and is to determine that the reception state of the location signal is in a second state when the reception rate of the location signal is equal to or less than the preset reference value.

The sensor arrangement may include a plurality of sensors to facing forward, backward, and left and right sides of the wearable display device. The sensors may be removably attached to the frame. The wearable display device may include a memory to stores map data, wherein the display is to display the movement direction of the wearable display device on an image of a map based on the map data.

In accordance with one or more other embodiments, a wearable display device includes a frame; a display, on the frame, to display an image based on a control signal; a location signal receiver to receive location information of the wearable display device; a sensor arrangement on the frame and including one or more sensors to obtain distance information of one or more surrounding objects; an interface to receive information corresponding to selection of an operating mode; and a controller including a movement direction calculator to calculate a movement direction of the wearable display device based on the location information from the location signal receiver or the distance information from the sensor arrangement in a navigation mode based on the selection information, a control signal generator to generate the control signal based on the movement direction of the wearable display device, and a control signal transmitter to transmit the control signal to the display.

The movement direction calculator may calculate the movement direction of the wearable display device based on one of the location information or the distance information. The controller may include a location reception state identifier to identify a reception state of the location signal, wherein the movement direction calculator may calculate the movement direction of the wearable display device based on the location information when the reception state of the location signal is a first state, and may calculate the movement direction of the wearable display device based on the distance information when the reception state of the location signal is a second state.

The movement direction calculator may determine that the reception state of the location signal is the first state when the reception rate of the location signal exceeds a preset reference value, and may determine that the reception state of the location signal is in the second state when the reception rate of the location signal is equal to or less than the preset reference value.

The sensor arrangement may include a plurality of sensors facing forward, backward, and left and right sides of the wearable display device. The sensors may be removably attached to the frame. The wearable display device may include a memory to store map data, wherein the display is to display the movement direction on an image of a map based on the map data.

The controller may include a surrounding object approach monitor to identify whether the one or more surrounding objects are within a preset reference distance based on the distance information; and a surrounding object movement information calculator to calculate the movement direction of the one or more surrounding objects based on the distance information when the surrounding object approach monitor determines that the one or more surrounding objects are within the preset reference distance in a security mode corresponding to the selection information, wherein: the control signal generator is to generate the control signal based on the movement direction of the one or more surrounding objects, and the control signal transmitter is to transmit the control signal to the display.

The controller may include a surrounding object movement direction calculator to calculate a movement speed of the one or more surrounding objects based on the distance information, wherein the control signal generator is to generate the control signal based on the movement direction and the movement speed.

The wearable display device may include a notification circuit including at least one of a speaker or a vibrator, wherein the control signal generator is to generate a control signal for controlling operation of the notification circuit based on the movement direction of the one or more surrounding objects and wherein the control signal transmitter is to transmit the control signal to the notification circuit.

The sensor arrangement may include a plurality of sensors facing forward, backward, the left and right sides of the user, and above and below the user. The sensors may be removably attached to the frame. The wearable display device may include a memory to stores map data, wherein the display is to display the movement direction of the one or more surrounding objects on an image of a map based on the map data. The location signal receiver may be receive Global Positioning System (GPS) location information. The sensors may be ultrasonic sensors.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates an embodiment of a wearable display device;

FIG. 2 illustrates an internal embodiment of the wearable display device;

FIG. 3 illustrates another view of the wearable display device;

FIG. 4 illustrates an embodiment of a processor of the wearable display device;

FIG. 5 illustrates an embodiment of a control unit of the wearable display device;

FIG. 6 illustrates an embodiment of a method for driving the wearable display device in navigation mode;

FIG. 7 illustrates an example calculation of a user movement direction in navigation mode of the wearable display device; and

FIG. 8 illustrates an embodiment of a method for driving the wearable display device in security mode.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout. Embodiments may be combined to for additional embodiments.

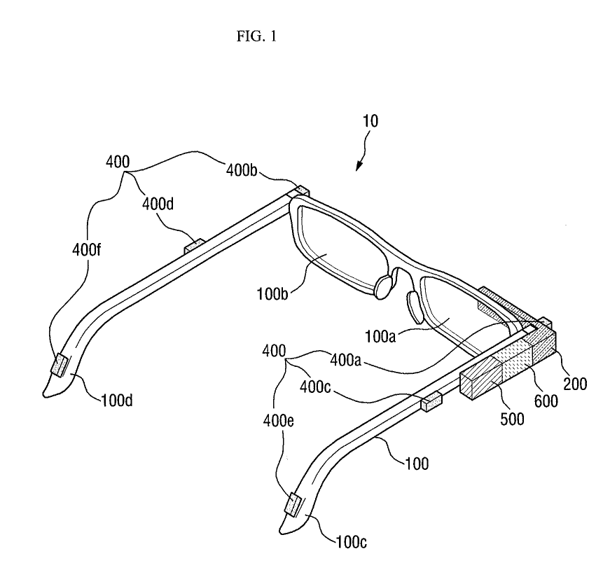

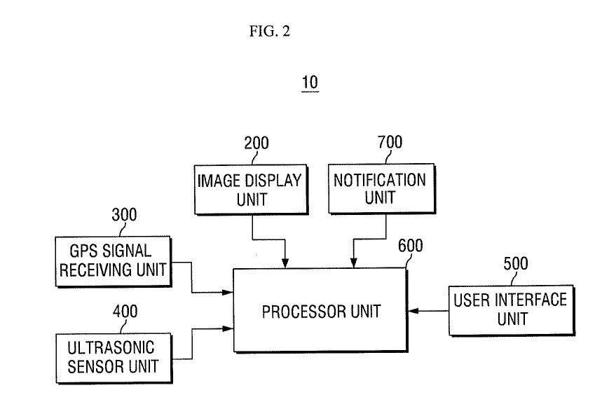

FIG. 1 illustrates an embodiment of a wearable display device 10, and FIG. 2 illustrates an embodiment of an internal circuit configuration of the wearable display device 10. Referring to FIGS. 1 and 2, the wearable display device 10 includes a frame 100, an image display unit 200, a global positioning system (GPS) signal receiving unit 300, an ultrasonic sensor unit 400, a user interface unit 500, a processor unit 600, and a notification unit 700. In one embodiment, these and/or other components of the wearable display device 10 may be mounted on the frame 100. The mounting may be, for example, a removable mounting in order to allow one or more of the features of the wearable display device 10 to be replaced or serviced or upgraded.

In another embodiment the signal receiving unit 300 may be another type of location system, including but not limited to WLAN location determination systems, systems which determine location based on a triangulation algorithm, time-based or beacon-signal based systems, as well as other systems.

The frame 100 may serve as a main body of the wearable display device 10 and may be structured to be wearable on the head of a user. As illustrated in FIG. 1, the frame 100 may be have a structure and appearance similar to a pair of glasses. The glasses may have clear lenses, prescription lenses, or tinted lenses, e.g., such as used in sunglasses. In another embodiment, the frame 100 may have a different shape that is wearable on the head of a user. Examples include a helmet, a headphone, a band, goggles, a monocle, a visor, or another type of frame that positions the display within the field of view of a user.

The frame 100 may be made of various materials including metals, plastics, polymers, and/or dielectrics. Making the frame 100 from a dielectric material may be advantageous, for example, when the wearable display device is used to perform computing operations and/or to receive radio frequency (RF) and GPS signals.

When shaped as a pair of glasses, the frame 100 may include two lens-mounting parts 100a and 100b. A user who needs prescription glasses may mount lenses onto the lens-mounting parts 100a and 100b. In addition, the frame 100 may include two support parts 100c and 100d for wearing the frame 100 on the ears of a user.

The image display unit 200 may provide the user with image information by displaying an image within the view of the user based on a control signal from the processor unit 600. The image display unit 200 may be installed on the frame 100 and placed in front of at least one eye of a user.

The image display unit 200 may include a micro-display having a size of about 1 inch for display images using various methods. The image display unit 200 may be at least partially made of a transparent material. Making the image display unit 200 of a transparent material may be more advantageous in securing a clear view, for example, when no image is displayed on the image display unit 200. In another embodiment, the image display unit may be made of a non-transparent material or a combination of transparent and non-transparent materials.

To display an image, the image display unit 200 may use an external light source or the image display unit 200 may be a self-illuminating system. An example of a self-illuminating system is display having pixels that use organic light-emitting diodes (OLEDs). An OLED generates light based on a combination of electrons and holes in an active layer between electrodes. When the electrons and holes combine, excitons are formed in an excited state. When the excitons transition to a stable state, light is emitted. Because an OLED is a self-emitting light source, an embodiment which uses OLEDs may display images without using an external light source, e.g., a backlight.

An example of a system using an external light source is a transmissive display. One such example is a thin-film transistor (TFT)-liquid crystal display (LCD). In such a display, light emitted from a backlight (e.g., cold cathode fluorescent lamp) is directed towards a liquid crystal panel by a reflecting and diffusing device. The liquid crystal panel includes twisted nematic (TN) liquid crystals between two glass sheets. One glass sheet is on the side where light enters includes TFT and indium tin oxide (ITO) pixels and a liquid crystal alignment layer. The other glass sheet is on the other side and is structured with a color filter and a coated liquid crystal alignment layer (polyimide).

Another example of a system using an external light source is a reflective display. One example of a reflective display is liquid crystal on silicon (LcoS) which displays an image by reflecting light from a light source. A silicon substrate may be mainly used for a display element, and high-resolution images may be displayed on a small display screen.

The image display unit 200 has a predetermined shape. In one embodiment, the image display unit 200 has a shape similar to an “L” and is placed on an upper side of the lens-mounting part 100a of the frame 100. In another embodiment, the image display unit 200 may have a different shape and/or different location. For example, the image display unit 200 may be placed on an upper side of the other lens-mounting part 100b or on an upper or lower side of each of the lens-mounting parts 100a and 100b.

The GPS signal receiving unit 300 receives information indicative of the location of the user. For example, a GPS signal received through the GPS signal receiving unit 300 may include location information and time information of a user searing the display device 10. The GPS signal receiving unit 300 may be connected to the processor unit 600, for example, by a cable or other electrical connector, to exchange electrical signals with the processor unit 600.

The GPS signal receiving unit 300 may be provided, for example, in the same housing as the user interface unit 500 or the processor unit 600 or may be provided in a separate housing or within the frame 100.

The ultrasonic sensor unit 400 obtains information about the user or his surroundings. For example, the ultrasonic sensor unit 400 may obtain distance information of objects around the user. The objects may include living and non-living things. The ultrasonic sensor unit 400 may also obtain information, for example, indicative of whether an object exists around the user, information about the movement of objects around the user and changes in locations of the objects, information about heights and curvatures of the objects around the user, and information about sizes and shapes of the objects around the user.

The ultrasonic sensor unit 400 may include one or more ultrasonic sensors 400a through 400f. The ultrasonic sensors 400a through 400f may be installed on the frame 100. Each of the ultrasonic sensors 400a through 400f may be connected to the processor unit 600, for example, by a cable or other electrical connector, to exchange electrical signals with the processor unit 600.

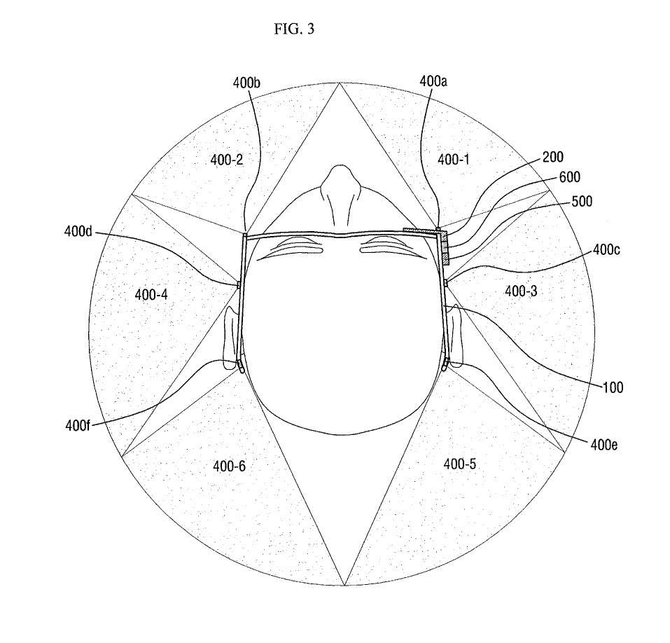

FIG. 3 illustrates a plan view of the user wearing the wearable display device 10. Referring to FIG. 3, the ultrasonic sensor unit 400 may include the ultrasonic sensors 400a and 400b facing in a forward direction for purposes of obtaining distance information of objects in front of the user. The ultrasonic sensor 400a may obtain distance information of objects, for example, in area 400-1 and in area 400-2 in front of the user. The ultrasonic sensors 400a and 400b may respectively be installed, for example, on upper sides of the lens-mounting parts 100a and 100b or on the image display unit 200.

In addition, the ultrasonic sensor unit 400 may include ultrasonic sensors 400c and 400d facing left and right sides in order to obtain distance information of objects on the sides of the user. For example, the ultrasonic sensor 400c may obtain distance information of objects in area 400-3 on the right side of the user, and the ultrasonic sensor 400d may obtain distance information of objects in area 400-4 on the left side of the user. When the frame 100 is shaped as glasses as illustrated in FIG. 3, the ultrasonic sensors 400c and 400d may face the left and right sides, for example, on parts of the frame 100 that correspond to legs (or temples) of the glasses.

In addition, the ultrasonic sensor unit 400 may include ultrasonic sensors 400e and 400f that face backward in order to obtain distance information of objects located behind the user. The ultrasonic sensor 400e may obtain distance information of objects in area 400-5 and area 400-6 behind the user. The ultrasonic sensors 400e and 400f may respectively be installed, for example, on the two support parts 100c and 100d as illustrated in FIG. 3.

The ultrasonic sensor unit 400 may further include one or more ultrasonic sensors facing upward and downward in order to obtain distance information of objects located above and below the user.

In one embodiment, ultrasonic sensors may be removably attached to the frame 100. For example, the ultrasonic sensors and the frame 100 may be coupled to and separated from each other. Accordingly, the user may select various types of ultrasonic sensors having various functions according to the intended application, thereby improving the convenience and functionality of use of the wearable display device 10. In another embodiment, the a different type of sensor arrangement (e.g., one is not an ultrasonic-type) may be used. Examples include light-based sensors or thermal-based sensors.

The user interface unit 500 receives control information from the user and provides the control information to the processor unit 600. The user interface unit 500 may receive from the user not only control information (e.g., power on/off) but also control information related to the overall operation of the wearable display device 10. For example, the user interface unit 500 may receive from the user information corresponding to the selection if or a change in an operating mode, as well as various types of control information concerning information retrieval, calls, and video playback.

The user interface unit 500 may be implemented in various forms. For example, the user interface unit 500 may be include multiple buttons or a planar interface (such as a mouse controller of a notebook computer) to receive control information from the user. The user interface unit 500 may be provided, for example, in the same housing as or a different housing from the processor unit 600.

In one embodiment, the processor unit 600 controls the overall operation of the wearable display device 10. The processor unit 600 may be connected to the user interface unit 500, for example, by a cable or other electrical connector, to exchange electrical signals with the user interface unit 500. The processor unit 600 may receive control information from the user interface unit 500 and process a user request based on the received control information. For example, the processor unit 600 may control the operation of the wearable display device 10 based on information corresponding to the selection of or a change in operating mode received from the user through the user interface unit 500.

The operating mode may include, for example, a navigation mode and a security mode. The navigation mode may be an operating mode in which movement direction information or direction information is provided to the user. The security mode may be an operating mode in which warning information about an object approaching the user is provided. In one embodiment, the wearable display device 10 may be implemented to operate in one of the navigation mode or the security mode, or both modes.

A user interface may be provided to allow the user to select or change the operating mode, for example between the navigation mode and the security mode. The wearable display device 10 may be operated in the navigation mode, the security mode, or in the navigation mode and the security mode simultaneously.

In the navigation mode, the processor unit 600 may calculate the movement direction of the user based on user location information from the GPS signal receiving unit 300 at specific intervals or distance information of objects around the user obtained by the ultrasonic sensor unit 400 at specific intervals, and may provide the calculated movement direction to the user.

In the security mode, the processor unit 600 may calculate the movement direction and speed of an object around the user based on the distance information of the object obtained by the ultrasonic sensor unit 400 and provide information indicative of the calculated movement direction and speed to the user.

The notification unit 700 may provide information to the user or alert the user using sound or vibrations. The notification unit 700 may include a speaker or a vibrator installed on the frame 100. The speaker or vibrator may be connected to the processor unit 600, for example, by a cable or other electrical connector, to exchange electrical signals with the processor unit 600. The speaker may be adjacent to the two support parts 100c and 100d, to thereby allow audio information to be effectively delivered to the user. The vibrator may in contact with or at a location which allows the user to sense vibration, e.g., the vibrator may be mounted on the two support parts 100c and 100d.

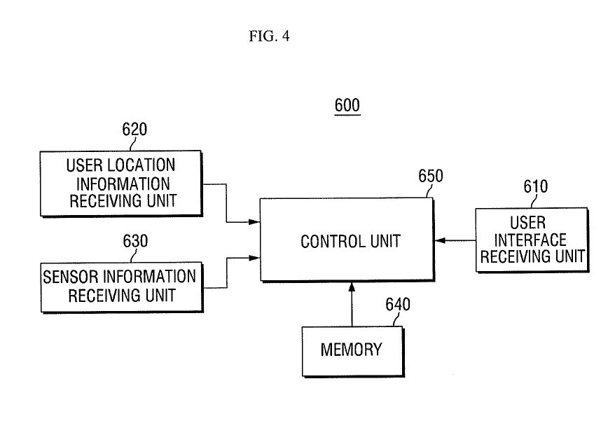

FIG. 4 illustrates an embodiment of the processor unit 600 of the wearable display device 10. Referring to FIG. 4, the processor unit 600 includes a user interface receiving unit 610, a user location information receiving unit 620, a sensor information receiving unit 630, a memory 640, and a control unit 650.

The user interface receiving unit 610 may be electrically connected to the user interface unit 500 to receive control information input by a user through the user interface unit 500. The control information may include, for example, information indicative of a selection of or a change in operating mode.

The user location information receiving unit 620 may be electrically connected to the GPS signal receiving unit 300 to receive a GPS signal containing user location information, for example, at specific intervals.

The sensor information receiving unit 630 may be electrically connected to the ultrasonic sensor unit 400 to receive distance information of objects around the user, for example, at specific intervals. In one embodiment, the sensor information receiving unit 630 may receive distance information from the ultrasonic sensors 400a through 400f. The distance information may be indicative of objects in front of, behind of, on sides of, and/or above or below the user.

The memory 640 may store programs and user data required for driving the wearable display device 10. For example, the memory 640 may store user location information from the user location information receiving unit 620 and distance information of objects around the user from the sensor information receiving unit 630. The memory 640 may also store map data for supporting the navigation mode and the security mode.

The control unit 650 may control the operation of the image display unit 200 and the notification unit 700 based on control information from the user interface receiving unit 610. For example, the control unit 650 may control the operation of the image display unit 200 and the notification unit 700 based on a GPS signal containing user location information from the user location information receiving unit 620 and distance information of objects around the user from the sensor information receiving unit 630, and according to the selection of or change information of the operating mode in the control information.

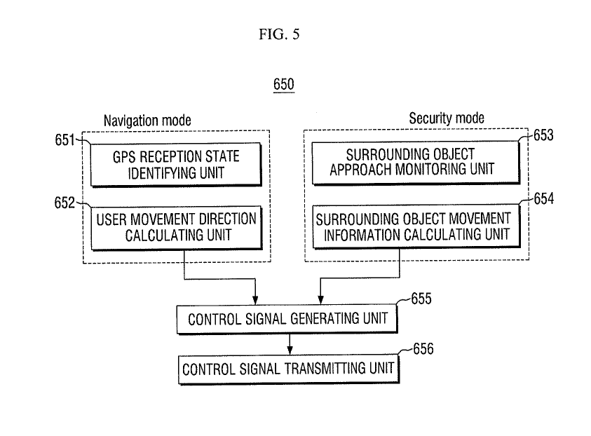

FIG. 5 illustrates an embodiment of the control unit 650 of the wearable display device 10. Referring to FIG. 5, the control unit 650 includes a GPS reception state identifying unit 651, a user movement direction calculating unit 652 for supporting the navigation mode, a surrounding object approach monitoring unit 653, a surrounding object movement information calculating unit 654 for supporting at least the security mode. The control unit 650 may further include a control signal generating unit 655 and a control signal transmitting unit 656.

First, operation in navigation mode based on a user selection is described.

The GPS reception state identifying unit 651 may identify the reception state of a GPS signal from the user location information receiving unit 620 at specific intervals. For example, when a reception rate of the GPS signal exceeds a preset reference value, the GPS reception state identifying unit 651 may determine that the reception state of the GPS signal is good. When the reception rate of the GPS signal is equal to or less than the preset reference value, the GPS reception state identifying unit 651 may determine that the reception state of the GPS signal is not good.

The user movement direction calculating unit 652 may calculate movement direction information of the user based on user location information from the user location information receiving unit 620 or distance information of objects around the user from the sensor information receiving unit 630.

The user movement direction calculating unit 652 may calculate the movement direction information of the user based on one of the user location information or the distance information of the objects around the user. For example, when the reception state of the GPS signal is good, the user movement direction calculating unit 652 may calculate the movement direction of the user based on the user location information from the user location information receiving unit 620. When the reception state of the GPS signal is not good, the user movement direction calculating unit 652 may calculate the movement direction of the user based on the distance information of the objects around the user from the sensor information receiving unit 630.

The control signal generating unit 655 may generate a control signal for controlling the operation of the image display unit 200 or the notification unit 700 based on the movement direction of the user calculated by the user movement direction calculating unit 652.

The control signal transmitting unit 656 may transmit the control signal generated by the control signal generating unit 655 to the image display unit 200 or the notification unit 700 which is to be controlled.

The image display unit 200 may indicate the movement direction of the user on a display screen, for example, using an arrow according to the control signal from the control signal transmitting unit 656. The image display unit 200 may indicate the movement direction of the user on a map of the user surroundings using, for example, map data stored in the memory 640. The notification unit 700 may include a speaker to output a sound to inform the user of the user movement direction based on the control signal from the control signal transmitting unit 656.

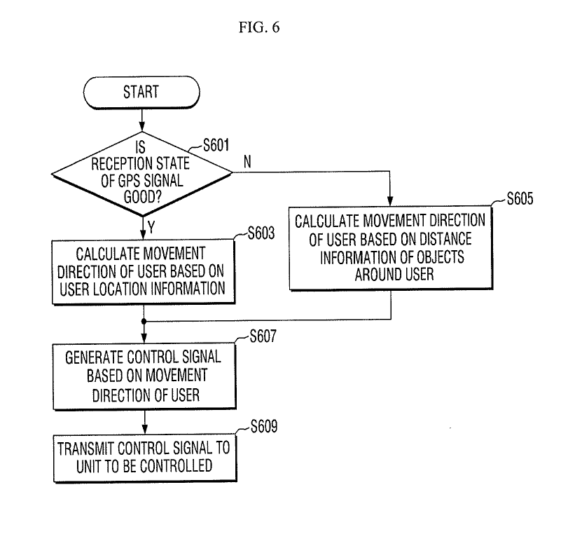

FIG. 6 illustrates an embodiment of a method for driving the wearable display device 10 in the navigation mode. Referring to FIG. 6, in the navigation mode, the control unit 650 identifies whether the reception state of a GPS signal from the user location information receiving unit 620 is good (operation S601).

For example, when a reception rate of the GPS signal from the user location information receiving unit 620 exceeds a preset reference value, the GPS reception state identifying unit 651 may determine that the reception state of the GPS signal is good. When the reception rate of the GPS signal is equal to or less than the preset reference value, the GPS reception state identifying unit 651 may determine that the reception state of the GPS signal is not good.

When it is determined in operation S601 that the reception state of the GPS signal is good, the user movement direction calculating unit 652 may calculate a movement direction of a user based on user location information from the user location information receiving unit 620 (operation S603). When it is determined in operation S601 that the reception state of the GPS signal is not good, the user movement direction calculating unit 652 may calculate the movement direction of the user based on distance information of objects around the user from the sensor information receiving unit 630 (operation S605).

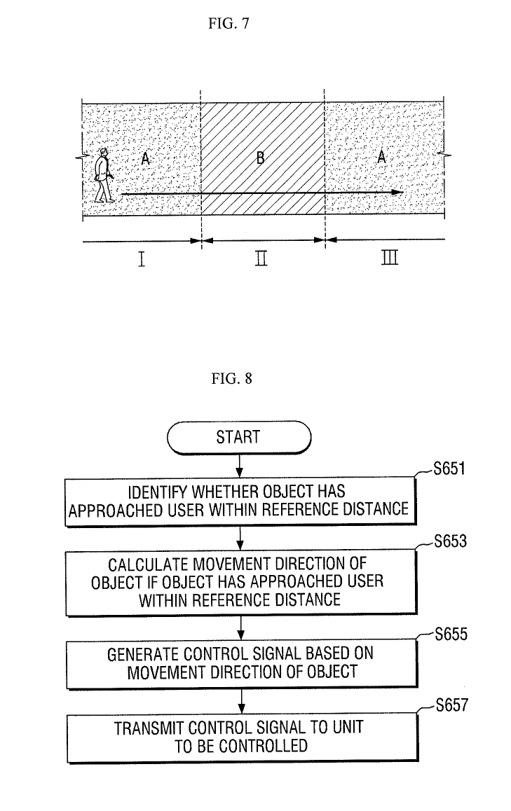

FIG. 7 illustrates an example of a calculation of the user movement direction to be performed in the navigation mode of the wearable display device 10. Referring to FIG. 7, areas I and III are areas in which the reception state of a GPS signal is good (A). Area II is an area in which the reception state of the GPS signal is not good (B). The user may sequentially pass through the areas I, II, and II in the navigation mode of the wearable display device 10. In this case, the GPS signal reception state of the wearable display device 10 is good when the user is in the areas I and III. Therefore, the movement direction of the user may be calculated based on user location information from the user location information receiving unit 620.

On the other hand, the GPS signal reception state of the wearable display device 10 is not good while the user is in the area II. Therefore, the movement direction of the user may be calculated based on distance information of objects around the user from the sensor information receiving unit 630.

Thus, even in an environment in which the GPS reception state is not good, the wearable display device 10 may continuously calculate the movement direction of the user based on the distance information of the objects around the user obtained by the ultrasonic sensor unit 400. Therefore, the wearable display device 10 may smoothly perform a navigation operation.

The control signal generating unit 655 may generate a control signal for controlling the operation of the image display unit 200 or the notification unit 700 based on the user movement direction calculated in operation S603 or S605 (operation S607).

The control signal transmitting unit 656 may transmit the control signal generated by the control signal generating unit 653 to the image display unit 200 or the notification unit 700 which is to be controlled (operation S609).

Second, operation in the security mode based on the user selection is described.

Referring back to FIG. 5, in the security mode, the surrounding object approach monitoring unit 653 monitors the approach of a surrounding object to the user. The surrounding object approach monitoring unit 653 may identify whether a surrounding object has approached the user, for example, within a preset reference distance, based on distance information of objects around the user from the sensor information receiving unit 630 at specific intervals.

When the surrounding object approach monitoring unit 653 determines that the surrounding object has approached the user within the preset reference distance, the surrounding object movement information calculating unit 654 may calculate the movement direction of the surrounding object based on the distance information of the objects around the user from the sensor information receiving unit 630 at the specific intervals. The user location information from the user location information receiving unit 620 may be used, for example, to calculate the movement direction of the surrounding object. In addition, the surrounding object movement information calculating unit 654 may calculate the movement speed of the surrounding object based on the distance information of the objects around the user from the sensor information receiving unit 630, for example, at the specific intervals.

The control signal generating unit 655 may generate a control signal for controlling the operation of the image display unit 200 or the notification unit 700 based on the movement direction and/or speed of the surrounding object calculated by the surrounding object movement information calculating unit 654.

The control signal transmitting unit 656 may transmit the control signal generated by the control signal generating unit 655 to the image display unit 200 or the notification unit 700 which is to be controlled.

The image display unit 200 may display movement directions of the objects around the user, for example, using arrows on the display screen according to the control signal received from the control signal transmitting unit 656. For example, the movement direction of one or more objects in front of the user may be displayed on an upper side of the display screen. The movement directions of objects on the left and right sides of the user may respectively be displayed on the left and right sides of the display screen. The movement direction of one or more objects behind the user may be displayed on a lower side of the display screen.

In addition, an edge portion of the display screen (which corresponds to the movement direction of a surrounding object) may be curled up or folded to visually indicate the movement direction of the surrounding object. In another embodiment, a different method may be used to indicate the movement directions of surrounding objects. For example, instead of arrows, different graphical objects may be used. Also, the nearness or proximity of the objects may be indicated, for example, using different colors or other graphical techniques. Additional examples are described below.

The image display unit 200 may indicate the movement direction of a surrounding object in view of the movement speed of the surrounding object. For example, when the movement direction of the surrounding object is represented by an arrow, the size of the arrow may be increased as the movement speed of the surrounding object increases. Alternatively, the arrow may have a different color or a different flickering interval according to the movement speed of the surrounding object. Other methods of indicating the movement speed of surrounding object may be used in other embodiments.

The image display unit 200 may indicate the movement directions of objects around the user on a map of the user surroundings, for example, based on map data stored in the memory 640.

The notification unit 700 including the speaker may inform or alert the user of a direction in which a surrounding object is approaching the user according to the control signal from the control signal transmitting unit 656. The notification unit 700 including the vibrator may alert the user through vibrations according to the control signal from the control signal transmitting unit 656. In another embodiment, the image display unit 200 or the notification unit 700 may operate in various other ways to make the user aware of the approach of a surrounding object.

FIG. 8 illustrates an embodiment of a method for driving the wearable display device 10 in the security mode. Referring to FIG. 8, the surrounding object approach monitoring unit 653 identifies whether an object has approached a user, for example, within a preset reference distance, based on distance information of objects around the user from the sensor information receiving unit 630. The distance information may be received, for example, at specific intervals (operation S651).

When it is determined in operation S651 that the object has approached the user within the preset reference distance, the surrounding object movement information calculating unit 654 calculates the movement direction of the object based on the distance information of one or more objects around the user from the sensor information receiving unit 630 at the specific intervals (operation S653). In addition, the surrounding object movement information calculating unit 654 may calculate the movement speed of the object based on the distance information of the objects around the user from the sensor information receiving unit 630 at the specific intervals.

Next, the control signal generating unit 655 may generate a control signal for controlling the operation of the image display unit 200 or the notification unit 700 based on the movement direction of the object calculated in operation S653 (operation S655). The control signal may be generated based on the movement speed of the object. The control signal transmitting unit 656 may transmit the control signal generated by the control signal generating unit 653 to the image display unit 200 or the notification unit 700 which is to be controlled (operation S657).

The control units, calculators, location determination units, sensing units, and other processing features of the aforementioned embodiments may be implemented in logic which, for example, may include hardware, software, or both. When implemented at least partially in hardware, the control units, calculators, location determination units, sensing units, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the control units, calculators, location determination units, sensing units, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

By way of summation and review, HMDs are anticipated to be used both indoors and outdoors. Because the HMD display significantly affects the vision of its user, the safety of the user may be compromised especially when used outdoors. For example, when a user wearing an HMD is walking on the street, his vision may be hindered to the extent that he will not be able to recognize a suddenly appearing vehicle or other dangerous objects. In accordance with one or more of the aforementioned embodiments, a wearable display device may operate in a navigation mode even in an environment in which a GPS reception state is not good. In addition, a wearable display device may overcome limitations that may impair user vision to thereby promote user safety.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A wearable display device, comprising:
a frame;
a display, on the frame, to display an image based on a control signal;
a location signal receiver to receive location information of the wearable display device;
a sensor arrangement on the frame and including one or more sensors to determine distance information of one or more surrounding objects; and
a controller including a movement direction calculator to calculate a movement direction of the wearable display device based on the location information from the location signal receiver or the distance information from the sensor arrangement, a control signal generator to generate the control signal based on the movement direction, and a control signal transmitter to transmit the control signal to the display.

2. The wearable display device as claimed in claim 1, wherein the movement direction calculator is to calculate the movement direction of the wearable display device based on one of the location information or the distance information.

3. The wearable display device as claimed in claim 1, wherein the controller includes a location reception state identifier to identify a reception state of the location signal, wherein:
the movement direction calculator is to calculate the movement direction of the wearable display device based on the location information when the reception state of the location signal is indicative of a first state and is to calculate the movement direction of the wearable display device based on the distance information when the reception state of the location signal is in a second state.

4. The wearable display device as claimed in claim 3, wherein the movement direction calculator is to determine that the reception state of the location signal is in the first state when the reception rate of the location signal exceeds a preset reference value, and is to determine that the reception state of the location signal is in a second state when the reception rate of the location signal is equal to or less than the preset reference value.

5. The wearable display device as claimed in claim 1, wherein the sensor arrangement includes a plurality of sensors to facing forward, backward, and left and right sides of the wearable display device.

6. The wearable display device as claimed in claim 1, wherein the sensors are removably attached to the frame.

7. The wearable display device as claimed in claim 1, further comprising:
a memory to stores map data,
wherein the display is to display the movement direction of the wearable display device on an image of a map based on the map data.

8. A wearable display device, comprising:
a frame;
a display, on the frame, to display an image based on a control signal;
a location signal receiver to receive location information of the wearable display device;
a sensor arrangement on the frame and including one or more sensors to obtain distance information of one or more surrounding objects;
an interface to receive information corresponding to selection of an operating mode; and
a controller including a movement direction calculator to calculate a movement direction of the wearable display device based on the location information from the location signal receiver or the distance information from the sensor arrangement in a navigation mode based on the selection information, a control signal generator to generate the control signal based on the movement direction of the wearable display device, and a control signal transmitter to transmit the control signal to the display.

9. The wearable display device as claimed in claim 8, wherein the movement direction calculator is to calculate the movement direction of the wearable display device based on one of the location information or the distance information.

10. The wearable display device as claimed in claim 9, wherein the controller includes a location reception state identifier to identify a reception state of the location signal, wherein the movement direction calculator is to calculate the movement direction of the wearable display device based on the location information when the reception state of the location signal is a first state, and is to calculate the movement direction of the wearable display device based on the distance information when the reception state of the location signal is a second state.

11. The wearable display device as claimed in claim 10, wherein the movement direction calculator is to determine that the reception state of the location signal is the first state when the reception rate of the location signal exceeds a preset reference value, and is to determine that the reception state of the location signal is in the second state when the reception rate of the location signal is equal to or less than the preset reference value.

12. The wearable display device as claimed in claim 8, wherein the sensor arrangement includes a plurality of sensors facing forward, backward, and left and right sides of the wearable display device.

13. The wearable display device as claimed in claim 8, wherein the sensors are removably attached to the frame.

14. The wearable display device as claimed in claim 8, further comprising:
a memory to store map data,
wherein the display is to display the movement direction on an image of a map based on the map data.

15. The wearable display device as claimed in claim 8, wherein the controller includes:
a surrounding object approach monitor to identify whether the one or more surrounding objects are within a preset reference distance based on the distance information; and
a surrounding object movement information calculator to calculate the movement direction of the one or more surrounding objects based on the distance information when the surrounding object approach monitor determines that the one or more surrounding objects are within the preset reference distance in a security mode corresponding to the selection information, wherein:
the control signal generator is to generate the control signal based on the movement direction of the one or more surrounding objects, and the control signal transmitter is to transmit the control signal to the display.

16. The wearable display device as claimed in claim 15, wherein the controller includes:
a surrounding object movement direction calculator to calculate a movement speed of the one or more surrounding objects based on the distance information, wherein the control signal generator is to generate the control signal based on the movement direction and the movement speed.

17. The wearable display device as claimed in claim 15, further comprising:
a notification circuit including at least one of a speaker or a vibrator,
wherein the control signal generator is to generate a control signal for controlling operation of the notification circuit based on the movement direction of the one or more surrounding objects and wherein the control signal transmitter is to transmit the control signal to the notification circuit.

18. The wearable display device as claimed in claim 15, wherein the sensor arrangement includes a plurality of sensors facing forward, backward, the left and right sides of the user, and above and below the user.

19. The wearable display device as claimed in claim 15, wherein the sensors are removably attached to the frame.

20. The wearable display device as claimed in claim 15, further comprising:
a memory to stores map data,
wherein the display is to display the movement direction of the one or more surrounding objects on an image of a map based on the map data.
